(19) United States
(12) Patent Application Publication
(10) Pub. No.: US 2026/0350990 A1
(43) Pub. Date: Nov. 5, 2026

(54) METHOD TO LEARN VIEW-INVARIANT REPRESENTATIONS FOR SELF-SUPERVISED MULTI-VIEW PROCEDURE UNDERSTANDING

(71) Applicant: NEC Laboratories America, Inc., Princeton, NJ (US)

(72) Inventors: Deep Patel, Mount Holly, NJ (US); Iain Melvin, Princeton, NJ (US); Renqiang Min, Princeton, NJ (US); Sanjoy Kundu, Greensboro, NC (US)

(21) Appl. No.: 19/660,536

(22) Filed: Apr. 28, 2026

Related U.S. Application Data
(60) Provisional application No. 63/798,043, filed on May 1, 2025.

(51) Int. Cl. G06V 20/40; G06V 10/762; G06V 10/764

(52) U.S. Cl. CPC G06V 20/44; G06V 10/762; G06V 10/764; G06V 20/42; G06V 20/46

(57) ABSTRACT

Systems and methods for learning view-invariant representations for self-supervised multi-view procedure understanding. The systems and methods include encoding features in video frames, the video frames including key point events captured from different viewpoints at a same time, at least one viewpoint being an egocentric viewpoint and at least one viewpoint being an exocentric viewpoint, selecting several consecutive video frames to form at least two temporally aligned sequences, and classifying the features including predicting a viewpoint from which a given feature originates. The systems and methods further include aligning feature sequences to facilitate temporally logical embeddings across viewpoints, identifying at least one anomalous key point event from the prediction, and performing an action responsive to the at least one identified anomalous key point event.

### RELATED APPLICATION INFORMATION

This application claims priority to U.S. Provisional Patent App. No. 63/798,043, filed on May 1, 2025, incorporated herein by reference in its entirety.

### BACKGROUND

### Technical Field

The present invention relates to computer vision, and more particularly applying labels to actions identified in videos to ensure processes are performed accurately and completely.

### Description of the Related Art

Identifying and tracking processes can be useful for tasks such as, e.g., being indicative of failure/error rate and productivity, and informative of bottlenecks, pain points, etc. Knowledge of processes can help improve processes, such as, e.g., identifying problems and implementing resolutions to the problems. Some solutions for identifying and tracking processes include capturing visual data about the process and analyzing the information with computer vision (CV) techniques. These solutions often use several cameras to capture videos or photographs from multiple views which can avoid blind spots, but can present challenges, especially in a self-supervised setting where frame-level annotations are unavailable.

Manually annotating long, multi-view videos with fine grained temporal information (like key step boundaries) can be prohibitively expensive and time-consuming. Self-supervised learning methods avoid the problems of manually annotating labels, but can present other challenges, such as, e.g., high computational costs associated with processing multiple, synchronized video streams.

Further, loading and concurrently processing frames from several high-resolution videos can demand significant memory and computational power, and can exceed practical limits. These constraints can hinder scalability and can render in naive multi-view extensions of existing algorithms that are computationally infeasible for long procedural videos. Such multi-view extensions are typically simple, inefficient extensions which are designed for short video clips (e.g., several seconds) and are not capable of extending to long procedural videos spanning e.g., several minutes or hours.

Additionally, some self-supervised techniques for temporal understanding are designed for a single input video stream. Adapting these methods to effectively fuse information and learn coherent feature representations across multiple, potentially disparate, viewpoints can necessitate applying non-trivial modifications or entirely new architectures. These modifications or new architectures can increase complexity and potentially lose the benefits of the original well-studied single-view approaches.

### SUMMARY

According to an aspect of the present invention, a method is provided for a method to learn view-invariant representations for self-supervised multi-view procedure understanding. The method includes encoding features in video frames, the video frames including key point events captured from different viewpoints at a same time, at least one viewpoint being an egocentric viewpoint and at least one viewpoint being an exocentric viewpoint. selecting several consecutive video frames to form at least two temporally aligned sequences, and classifying the features including predicting a viewpoint from which a given feature originates. The method further includes aligning feature sequences to facilitate temporally logical embeddings across viewpoints, identifying at least one anomalous key point event from the prediction, and performing an action responsive to the at least one identified anomalous key point event.

According to another aspect of the present invention, a system is provided for learning view-invariant representations for self-supervised multi-view procedure understanding. The system includes a processor and a memory storing computer-readable instructions. The memory, when executed by the processor, cause the processor to encode features in video frames, the video frames including key point events captured from different viewpoints at a same time, at least one viewpoint being an egocentric viewpoint and at least one viewpoint being an exocentric viewpoint, select several consecutive video frames to form at least two temporally aligned sequences, and classify the features including predicting a viewpoint from which a given feature originates. The memory further causes the processor to align feature sequences to facilitate temporally logical embeddings across viewpoints, identify at least one anomalous key point event from the prediction, and perform an action responsive to the at least one identified anomalous key point event.

Yet according to another aspect of the present invention, a computer program product including a non-transitory computer-readable storage medium containing computer program code is provided for learning view-invariant representations for self-supervised multi-view procedure understanding. The computer program product when executed by one or more processors causes the one or more processors to perform operations, the computer program code includes instruction to encode features in video frames, the video frames including key point events captured from different viewpoints at a same time, at least one viewpoint being an egocentric viewpoint and at least one viewpoint being an exocentric viewpoint, select several consecutive video frames to form at least two temporally aligned sequences, and classify the features including predicting a viewpoint from which a given feature originates. The computer program product further includes instructions to align feature sequences to facilitate temporally logical embeddings across viewpoints, identify at least one anomalous key point event from the prediction, and perform an action responsive to the at least one identified anomalous key point event.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level system for learning view-invariant representations for self-supervised multi-view procedure understanding, in accordance with an embodiment of the present invention;

FIG. 2 is a block diagram illustrating key step embeddings module, in accordance with an embodiment of the present invention;

FIG. 3 is a block diagram illustrating frame alignment module, in accordance with an embodiment of the present invention;

FIG. 4 is a block diagram illustrating object embedding and key step embedding alignment module, in accordance with an embodiment of the present invention;

FIG. 5 is a block diagram illustrating frame embedding classifying module, in accordance with an embodiment of the present invention;

FIG. 6 is a block diagram illustrating a view alignment module, in accordance with an embodiment of the present invention;

FIG. 7 is a block diagram illustrating learning view-invariance in deployment, in accordance with an embodiment of the present invention;

FIG. 8 is a flow diagram illustrating methods for learning view-invariant representations for self-supervised multi-view procedure understanding, in accordance with embodiments of the present invention;

FIG. 9 is a block diagram illustrating encoding features for learning view-invariant representations for self-supervised multi-view procedure understanding, in accordance with embodiments of the present invention;

FIG. 10 is a flow diagram illustrating classifying features for learning view-invariant representations for self-supervised multi-view procedure understanding, in accordance with embodiments of the present invention; and

FIG. 11 is a block diagram illustrating a system for a computing environment for executing learning view-invariant representations for self-supervised multi-view procedure understanding, in accordance with an embodiment of the present invention.

### DETAILED DESCRIPTION OF PREFERRED EMBODIMENTS

Understanding human activities and procedures from video data is an objective in computer vision (CV), with applications ranging from robotics and autonomous systems to instructional video analysis and augmented reality. Many real-world processes (procedures), such as assembling furniture, performing maintenance, or cooking are complex tasks that can span several minutes or longer, and can be captured in videos from multiple perspectives simultaneously to capture different aspects and details of the process. The complexity, duration, and various views can incorporate challenges in process review and optimization efforts.

The different views can include an egocentric (first-person) view, which can provide detailed information about manipulation and tool usage, while multiple exocentric (third-person) views offer broader spatial context, track object states, avoid motion blur, and overcome occlusions present in the ego-view. Leveraging this complementary information from multiple viewpoints can aid in robust and comprehensive process understanding and optimization.

Embodiments of the present invention automate understanding of processes captured in videos from multiple views (an egocentric and one or more exocentric views). The process understanding involves recognizing key steps and recognizing missing, improper, or out of order portions (steps) of the process. A process can be a procedure, method, operation, sequence, workflow, routine, protocol, event, etc. The process can range from, e.g., pouring water out of a cup, to manufacturing and assembling a vehicle. Monitoring processes for optimizing these steps can help reduce errors, improve productivity, and can assist workers to learn new tasks efficiently. Steps of the process can be also considered stages, actions, operations, portions, sub-processes, sub-steps, segment, etc. The relevant, useful, or otherwise notable portions of the process can be key points, or key point events.

Embodiments of the present invention can include a self-supervised method of training a framework (e.g., a model) to learn representations of processes in videos that are view-invariant. In other words, the processes can be represented across egocentric and exocentric viewpoints. An alternative embodiment of the present invention can be a self-supervised (or otherwise unsupervised) method. The view-invariance ensures that semantically equivalent actions or process steps are encoded consistently across differing viewpoints, thereby enabling robust alignment, comparison, and transfer of learned representations between views. This can improve generalization across camera perspectives, facilitate cross-view correspondence and temporal segmentation, and reduce sensitivity to view-specific artifacts such as occlusion, scale, or camera motion.

The framework can leverage temporally synchronized multi-view videos to learn spatiotemporal features that are robust to viewpoint variations, while preserving fine-grained procedural dynamics. Some of the components of the framework include a view-invariance objective using adversarial learning via a gradient reversal layer (GRL) and a temporal alignment to encourage consistency across different views over time.

Recognizing these representations can improve the performance of downstream tasks by recognizing key (e.g., important, high-value, significant) steps, and detecting when the key steps are missing, improper, or out-of-order steps. For example, a key step can include applying thermal paste or solder on an electrical component. If the thermal paste or solder is misapplied, the electrical component can be rendered effectively useless. Meaning, ensuring the thermal paste or solder is applied correctly can be more consequential than e.g., fixing two components together with a screw. The framework can identify the mistake and even generate solutions to notify the technician or another party of the mistake. Based on the identification the framework can provide a corrective action such as, e.g., training the technician how to properly apply thermal paste, making the technician and/or management aware of the mistake to proactively rectify the mistake, ordering new parts, creating reports on how frequently the mistake occurs, ordering tools to mitigate or prevent the mistake, etc.

An additional example can include folding paper into a paper airplane. The key steps can include acquiring paper, folding the paper in half, folding from a top left corner, folding from a top right corner, and flipping the paper airplane over. The importance and granularity of each key step can be considered. Further the method can determine and recognize all the steps involved in the procedure and whether they are performed properly. The granularity of the steps can be defined and modified based on application requirements.

The framework can employ an efficient frame sampling strategy (e.g., temporal frame mixing) that significantly reduces the computational cost of processing long multi-view procedural videos. The frame sampling strategy samples frames from different views to learn representations without processing all the data from each of the views.

The framework can include a method that enables the direct application of an existing single-view self-supervised algorithm for key step segmentation and classification in the multi-view setting without architectural changes, and an adversarial learning component to explicitly learn view-invariant representations helpful for consistent multi-view procedure understanding.

Embodiments of the present invention can train a framework by using a mixing module which mixes videos from multiple views to reduce memory and compute requirements while using a single-view procedure understanding algorithm. The self-supervised learning method helps learn view-invariant feature representations while enforcing spatial and temporal alignment of the video clips from multiple views.

The method ensures the framework understands the steps involved in the process as well as the hand-object interactions for each key step. The self-supervised learning algorithm also utilizes the key step descriptions for the procedure to learn object centric information by associating key step description with the state of the object at each key step. Aspects of the method include spatial and temporal alignment losses in the self-supervised learning method (algorithm) and the multi-view video mixing module which mixes frames from multiple view procedure videos, allowing the method to learn multi-view invariant representations without annotations and using single-view alignment losses. A GRL and view classifier/alignment module also help the framework learn multi-view agnostic features while reducing training cost, time, and computational resources.

Embodiments of the present invention train clips by randomly sampling frames from across available views (ego and exo) spanning the duration of the process (instead of loading synchronized multi-view clips). This generates a single, synthesized video stream for each process instance, which can reduce the simultaneous data loading requirements and associated computing costs. This frame mixing strategy can also directly leverage powerful, existing single-view self-supervised learning algorithms, such as, e.g., Temporal Cycle Consistency (TCC), CARL, etc. without modification or with minimal modification. These frameworks can operate on the mixed-view clip to learn temporal structures and segment the process into meaningful key steps, using video data and associated high-level textual step descriptions for grounding.

To facilitate the learning of view-invariant representations, an adversarial learning mechanism can be integrated into the method. Additionally, an auxiliary classifier, using frame-wise or view-wise pseudo-labels (e.g., egocentric view v. exocentric view), can predict the original viewpoint of individual frames within the learned feature space. A GRL can be employed and be applied to penalize the main feature extractor if the view classifier performs well, ensure the representations are view invariant. In other words, this adversarial pressure forces the extractor to learn representations that are discriminative for the process content but invariant to the specific camera viewpoint, making the learned representations robust and generalizable for multi-view analysis.

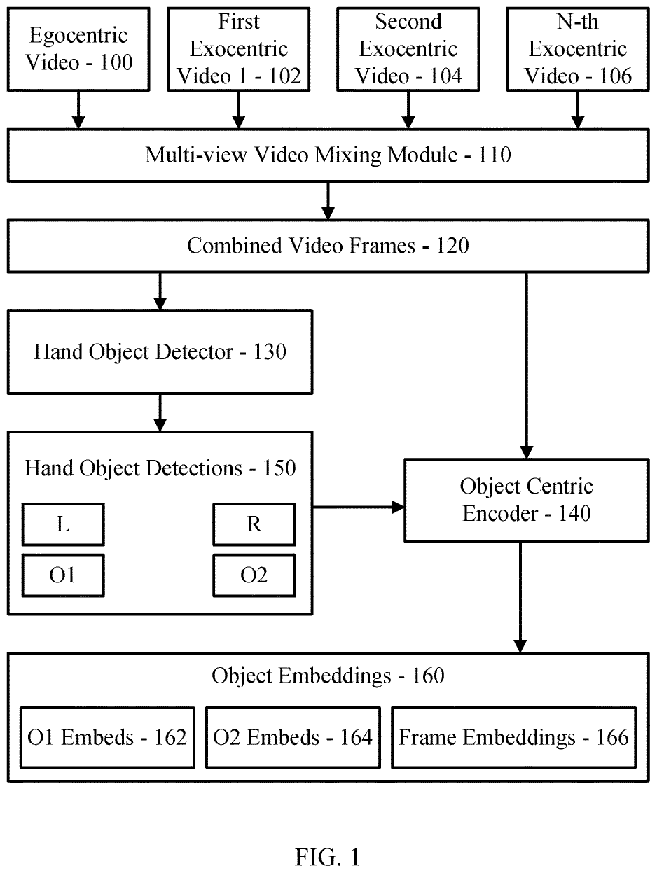

Referring now in detail to the figures in which like numerals represent the same or similar elements and initially to FIG. 1, a high-level block diagram for a method to learn view-invariant representations for self-supervised multi-view procedure understanding.

Video feeds from egocentric video 100, first exocentric video 102, second exocentric video 104, and n-th exocentric video 106 can generate video frames for use in embodiments of the present invention. These frames can be denoted as [symbol] ={V₁, V₂, . . . V_{K}}, where [symbol] is a set of temporally synchronized multi-view video recordings of the same activity, captured from K different viewpoints including both egocentric and exocentric perspectives.

The video feeds can be captured from egocentric views or exocentric views. There can be any number of exocentric video feeds, each having different views (perspectives), and are different from egocentric video 100. Images can be captured and used instead of frames of videos. Additional data modalities such as, e.g., infrared data, ultraviolet, sound, machine data, etc., can be implemented as well. A multimodal framework can learn representations of features from different types of sensors to learn features that include non-visual aspects.

In an embodiment of the present invention, the data from egocentric video 100, first exocentric video 102, second exocentric video 104, and n-th exocentric video 106 can be input to the multi-view video mixing module 110 which can randomly sample (or pseudo-randomly sample) from the views. The sampling can select frames with non-overlapping timestamps and subsequently generate a single video clip from the selected frames. Put differently, a clip can be constructed by randomly selecting frames from the variety of views at each sequential timestep. In this approach, frames corresponding to the same timestamp across different views are not jointly selected, and, within each view, sampled frames correspond to distinct timestamps.

In an embodiment of the present invention, multi-view video mixing module 110 can be implemented as a simple function with random (or pseudo-random) sampling and conditions for non-overlap between the views to form combined video frames 120. Combined video frames 120 can have a duration of any length, spanning from clips that last less than a second to clips that are several hours long. This is possible because any number of views can be learned in a set of video frames (e.g., clip)

The generated videos include frames from the available views allowing the model to learn view-invariant features without loading different views separately. The random sampling can result in several groups of consecutive frames from each video,

$${X}_{1} = \{ {x}_{1}^{R a n d ( k )} * l * K \} and {X}_{2} = \{ {x}_{2}^{R a n d ( k )} * l * K \} ,$$

where l is the length of the consecutive frames, K is the number of views, Rand(k) chooses a random view to sample the consecutive frames. Although these sequences originate from different viewpoints, the views are temporally synchronized and maintain the same relative temporal order.

The sampling can learn a shared representation function φ(⋅) that maps each frame to a view-invariant feature space, such that corresponding frames from X₁ and X₂, which depict the same moment in time from different views are mapped to similar feature representations. This mapping encourages the model to capture underlying semantic and temporal structures while discarding viewpoint-specific cues (e.g., lighting, shadows).

Combined video frames 120 can be passed to a hand object detector 130 which provides hand object detections 150 in the form of bounding box locations of the left and right hands of a user. Hand object detector 130 can also provide bounding boxes of one or more objects interacting with the left and right hands of the user. Hand object detector 130 can be off the shelf or custom built.

Combined video frames 120 and hand object detections 150 can be processed by object centric encoder 140. In an embodiment of the present invention, object centric encoder 140 can be implemented using a two dimensional (2D) convolutional neural network (CNN) or a transformer model combined with region of interest (ROI) align to extract objects and hand level information from the frame level features. The ROI align function can extract the features within the bounding box given the bounding box coordinates and the frame level features.

Alternative embodiments of the present invention can implement a vision transformer (ViT), graph neural network (GNN), a capsule network, a neural field, a graph attention network (GAT), a state space model (SSM), a recurrent neural network (RNN), attention pooling, ROI pooling, attention-based pooling, a patch-based or sliding window, key point extraction, etc.

Object centric encoder 140 can output embeddings for objects embeddings 160 and frame embeddings 166. O1 Embeds 162 and O2 Embeds 164 can be exemplary object embeddings such as, e.g., a pencil or an electric drill, which can be identified and interact with a left hand and right hand of hand object detections 150 either simultaneously, separately, or at different portions of a process.

Referring to FIG. 2, a key step embeddings module is illustrated. The module can generate key step noun embeddings 230 and key step noun embeddings 230. These embeddings can aid in the understanding of the objects better such as, e.g., enabling the framework to explicitly ground detected visual entities to semantic object identities and stabilize cross-sample correspondence of the same object category across varying appearances and contexts. By aligning key step noun embeddings 230 with object embeddings object embeddings 160, the model can reduce ambiguity in visually similar instances and enforce consistent object-level representation learning. This, in turn, supports more reliable association between what is seen in the frame and what the object is conceptually. Key step noun embeddings 230 can further aid in understanding the object better such as, e.g., non-visible or apparent characteristics of the object, by providing semantic priors that complement the visually observed features, enabling the model to infer properties like function, affordances, and state even when these are partially occluded or not directly observable in the frame. Then, by considering the learned start and end time of the key steps, noun extraction 210 aligns the start and end state of the object embeddings 160 (FIG. 1) across the training samples.

Key step descriptions 200 relating to the process can be processed by noun extraction 210 to extract nouns in the key step (e.g. in a key step description: “pick up an electric drill”, extracted noun: “electric drill”). Key step descriptions 200 can be natural language, though alternative embodiments of the present invention can incorporate machine language key step descriptions 200. Key step descriptions 200 can be descriptions of each portion of the process, with any amount of granularity. The granularity of each key step description 200 can change based on the importance or relative importance of each step. More relevant, valued, etc., key steps can be more granular than less relevant key steps. Key step descriptions 200 can be human generated or automatically generated based on outputs of computer vision techniques in combination with natural language generation models that relate to the process and the steps (e.g., key steps and non-key steps) of the process. Embodiments of the present invention can differentiate between steps and key steps of the process by applying natural language processing (MLP) techniques in a large language model (LLM) to key step descriptions 200 or from human in the loop (HITL) inputs.

Key step embeddings 240 and key step noun embeddings 230 can be generated by the text encoder 220 which directly receives key step descriptions 200, and nouns from noun extraction 210, respectively. Text encoder 220 can sub-tokenize words that are embedded. Embodiments of the present invention can include text encoder 220 as a semantic embedding of a vector. Alternative embodiments of the present invention can include embeddings such as static or contextual embeddings, incorporate state space models, apply contrastive embeddings or multi-modal embeddings, etc.

Key step embeddings 240 can be embeddings of the key step which include the object (e.g., noun) of the description that is being processed, as well as context, the action (e.g., verb) being done, adjectives relating to the object and action, etc. Key step noun embeddings 230 can include information about the object in the key step from key step description 200. Key step noun embeddings 230 can include more granularity of the object, or different context of the key step than key step embeddings 240.

Key step embeddings 240 and key step noun embeddings 230 can be used as training signals in self-supervised training. Since the information of the video clip performing the key step and key step description 200 can be relatively limited, corresponding embeddings can be applied to perform alignment (e.g., key step noun embeddings 230 and key step embeddings 240). This provides training signals that can be used to learn representations of processes in video frames that are view invariant (e.g., the identification of the process is not dependent on the view, or otherwise idiosyncratic from a view or group of views).

Object embeddings 160 from the video frames can also be matched with the key step noun embeddings 230 to align objects in video frames with the action the objects are performing or are being performed on the objects. The key step embedding 240 can be matched with a sequence of frame embeddings 166 to align the key steps with visual cues in the video frames in a view-invariant manner.

In an embodiment of the present invention, the noun extraction 210 can employ another deep learning model, e.g., a deep learning network (DLN), trained to extract nouns or a simple rule-based system that uses a natural language dictionary, e.g., English, with regular expression matching. Text encoder 220 can be a deep learning model that is trained to output semantically meaningful embeddings for sentences and/or words.

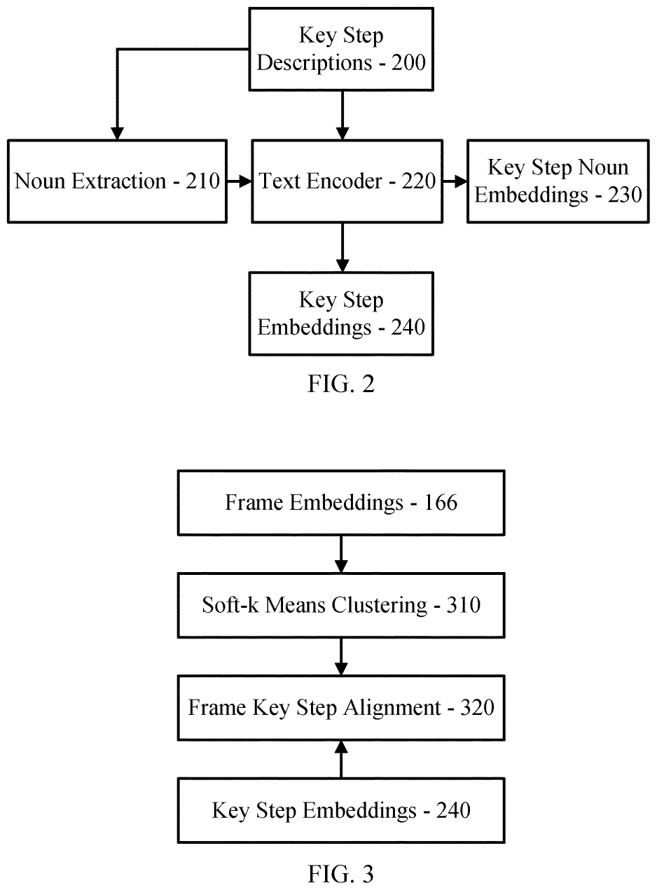

Referring to FIG. 3, a frame alignment module incorporated into the framework is illustratively depicted. The framework learns the distribution of the correct order of steps and motion information for each key step to perform a complex process by performing cross-view alignment of the frame wise embeddings from egocentric and exocentric views. To associate the grouping of frames with each key step, a contrastive loss can be applied between the learned key step embeddings 240 and a key step text embedding (e.g., key step noun embedding 230). This is further elaborated on in FIG. 6.

Frame embeddings 166 can be clustered using a soft clustering algorithm which is differentiable (e.g., soft-k means clustering 310 or a transformer decoder based cross attention) where the number of clusters is same as the number of key steps. This can ensure each frame can be classified as a part of a particular key step. A key step can be assigned to each frame embedding 166 and this assignment can be used to guide training of the model and helps identify boundaries of the key steps in the video clip, e.g., when in the set of frames each key step begins and ends.

The output clusters are aligned with key step description embeddings 240 using a frame key step alignment 320 module which can include contrastive loss formulation. The key step alignment module ensures alignment between the embeddings of the initial video frames, e.g., frame embeddings 166 and key step embeddings 240. In other words, key step embedding module can determine whether, and ensure, the framework is accurately correlating the collected data, e.g., egocentric video 100, first exocentric video 102, second exocentric video 104, n-th exocentric video 106 (FIG. 1), with the processed data, e.g., key step embeddings 240, of the same portion of the process.

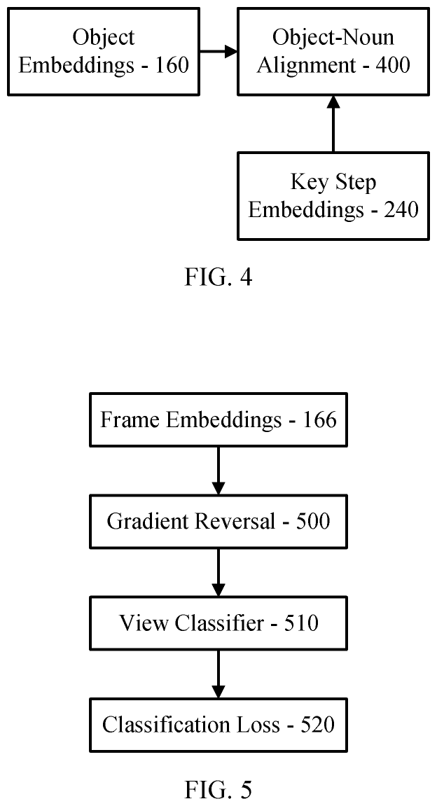

Referring to FIG. 4, an object embedding and key step embedding alignment module incorporated into the framework is illustratively depicted. Object embeddings 160 are aligned similarly to the key steps, with key step noun embeddings 230 using object-noun alignment 400 (e.g., a contrastive loss). In an embodiment of the present invention, the contrastive loss can be implemented as maximizing cosine similarity between the two types of embeddings. Other methods of implementing contrastive loss are also contemplated such as, e.g., Euclidean distance, Manhattan distance, Mahalanobis distance, dot product similarity, kernel-based similarity, etc.

Similar to the key step embedding module, the object embedding and key step embedding alignment module can determine whether, and ensure, the framework is accurately correlating the identified nouns, e.g., object embeddings 160 (FIG. 1), with the processed data, e.g., key step embeddings 240, of the same portion of the process.

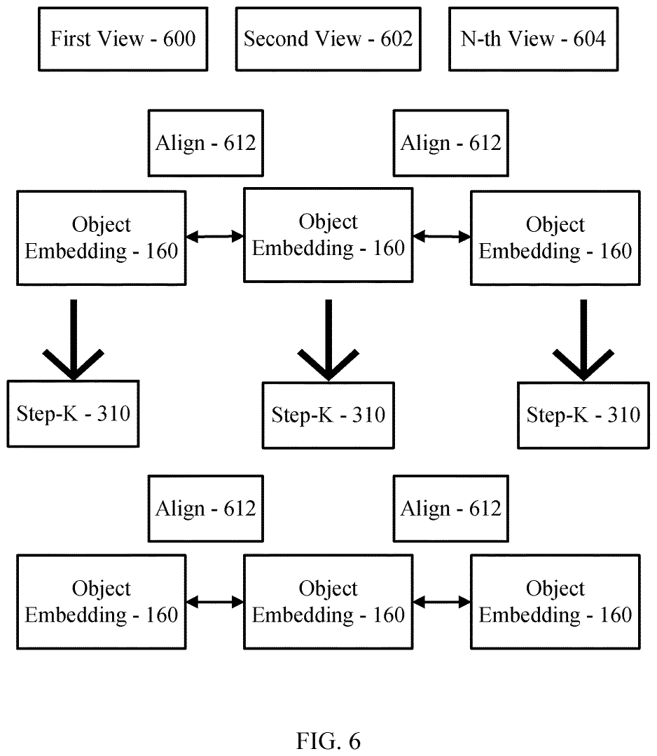

Referring to FIG. 5, an embedding classifier module incorporated into the framework is illustratively depicted. The framework classifies the frames into existing views acting as a discriminator during training to ensure that the frame features output by the framework do not include information about a specific view. Gradient reversal layer 500 before view classifier module 510 module trains the framework to move in the direction where there is no difference between features of frames from different views forcing the model to learn wholistic view agnostic understanding of each key step in the procedure.

Specifically, each frame

$${x}_{v}^{k}$$

is passed through a snared encode f_{θ}, resulting in feature representation

$${z}_{v}^{k} = {f}_{θ} ( {x}_{v}^{k} ) .$$

The features are then input to a view classifier 510 (D_{ψ}) that predicts the source view of each frame. Gradient reversal layer 500 is between f_{θ} and view classifier module 510 and inverts the gradients during backpropagation to encourage f_{θ} to produce features that confuse view classifier 510.

Classification loss 520 can be given as

$${ℒ}_{v i e w} = {\sum }_{k = 1}^{K} {\sum }_{t = 1}^{T} CE ( {D}_{ψ} ( {x}_{v}^{k} ) , {v}^{k} ) ,$$

where v^{k} is the one-hot encoding of view index k, and CE denotes cross-entropy loss. The encoder f_{θ} is trained to maximize classification loss 520 via gradient reversal layer 500, while view classifier module 510 is trained to minimize classification loss 520. This results in view-invariant feature representations.

Frame embeddings 166 can also be processed by a view classifier module 510 with a gradient reversal layer 500. Gradient reversal layer 500 is prefixed to view classifier module 510. View classifier module 510 can output the view classification of each frame from frame embeddings 166 and apply classification loss 520 (such as, e.g., cross entropy). In an embodiment of the present invention, the view classifier can be implemented using a multi-layer perceptron (MLP). The ground truth labels can be obtained from the multi-view video mixing module 110 (FIG. 1) which randomly (or pseudo-randomly) mixes the frames and has corresponding match information between the samples frame and the view video.

Referring to FIG. 6, a cross-view object embedding alignment module incorporated into the framework is illustratively depicted. After obtaining the clustering of frame embeddings 166, the start and end time of each key step is used to align 612 object embeddings 160 across different views (e.g., first view 600, second view 602, n-th view 604, etc.). There can be any number of views that correspond with egocentric video 100, first exocentric video 102, second exocentric video 104, n-th exocentric video 106. By tracking object embeddings 160 from the start time to end time, the cross-view object embedding alignment module can determine whether, and ensure, frame embeddings 166 of each view are correlated with each other for the same object embedding 160.

The state of the object at the start of the key step and at the end of the key step can be matched across the training samples to allow the model to learn spatial dynamics and changes in state of object after each key step. The number of steps taken to align object embeddings 160 can be pre-determined to be a number k, after the soft-k means clustering 310, the alignment can be complete.

While the view adversarial loss (classification loss 520 (FIG. 5)) removes viewpoint-specific signals, the loss does not explicitly enforce temporal consistency. Given two synchronized sequences (X₁, X₂) and their corresponding features (Zᵢ, Zⱼ), either TCC or dynamic time warping (DTW) can be applied to ensure temporal consistency, e.g., align feature sequences. The alignment loss encourages temporally coherent embeddings across views according to [symbol] =Align (Z₁, Z₂), where Align(⋅,⋅) denotes the alignment cost function TCC loss or DTW distance.

The total loss function is a weighted sum of the adversarial view-invariance loss and the temporal alignment loss, [symbol] =λ₁ [symbol] +λ₂ [symbol] , where λ₁ and λ₂ are hyperparameters balancing the contributions of each term.

During training of the framework, synchronized video portions are randomly sampled from different views while preserving their temporal order. The encoder can be shared and can be trained end-to-end using the combined objective. In some embodiments of the present invention supervision of action labels or viewpoints are not used, e.g., the framework can be self-supervised or otherwise unsupervised, making the framework broadly applicable across domains with multi-view video data. Once the self-supervised view invariant training is complete, the trained model can be used for multiple downstream tasks such as key step classification, frame retrieval given the key step or a similar frame retrieval across multiple views. The pretrained model can be finetuned with these kinds of tasks with limited annotated data as the model has already learned most of the skills for these tasks during the self-supervised training phase.

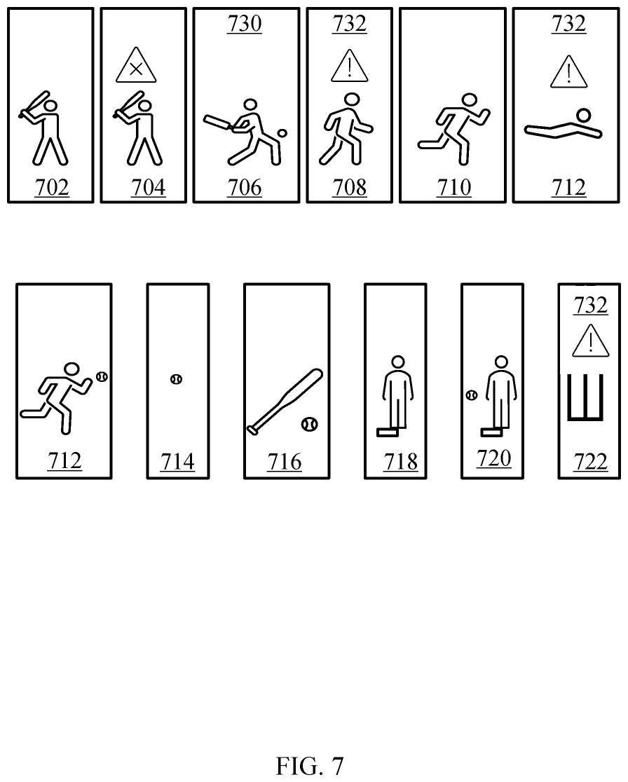

Referring to FIG. 7, a series of frames are illustratively depicted employing the framework, in accordance with an embodiment of the present invention. The framework can be used in processes such as, e.g., sports analytics or sports training. For example, playing offense in baseball can be quantized into key steps such as, e.g., detecting the pitch was thrown, tracking the baseball pitch, hitting the baseball, reacting to making contact, running to first base, reaching first base, etc. Video frames 702, 704, 706, 708, 710 illustrate one or more exocentric video frames. Video frames 712, 714, 716, 718, 720 illustrate egocentric video frames. While two views are depicted, any number of views can be included.

Failure notification 730 can identify a weakness in the key steps for future process refinement. Warning notification 732 can identify that an anomaly, unusual process, or other abnormality can be detected. The process anomaly can be on a scale or continuum from an expected result, where the amount of deviation determines whether failure notification 730, warning notification 732, some other notification, or no notification is sent. Video frames 702 and 712 correlate different views captured at the same time (e.g., temporally aligned).

Video frame 702 is of a batter detecting that the baseball pitch is thrown from an exocentric view. This temporally algins with video frame 712 from an egocentric view. Video frame 704 is the batter tracking the baseball pitch to determine the type of pitch and the location of the pitch. This temporally algins with video frame 714 from an egocentric view. Video frame 706 can be of hitting the baseball. This temporally algins with video frame 716 from an egocentric view.

Failure notification 730 can be present at video frame 706 because the swing of the bat is incorrect. For example, the swing can be a motion in cricket more so than baseball. Identifying this motion as being incorrect can trigger several downstream effects. Identifying an incorrect motion, can log/record and flag the key step frame that are anomalous. The framework can identify call key frames that are anomalous before and after this key frame for future review. The framework can identify solutions to resolve the problem such as, e.g., identifying internet articles that explain the difference between cricket and baseball swings, notify trainers, printing a natural language report of detailing the issue, etc. This temporally aligns with video frame 718 from an egocentric view. In video frame 718, the batter can see the first baseman standing on the base. Warning notification 732 can be present since the batter is not reacting quick enough and is jogging instead of running. Warning notification 732 can act the same or differently in remedial measure than failure notification 730. The differences between failure notification 730 and warning notification 732 can be that failure notification 730 does not have a justifiable explanation, while warning notification 732 does have a justifiable explanation, though other differences are also contemplated. For example, the batter can believe that the ball was hit as a homerun but later learns that the contact was not enough for the baseball to be a homerun.

Video frame 710 can be the batter running to first base. This temporally algins with video frame 720 from an egocentric view. Video frame 712 can be the batter reaching first base. This temporally algins with video frame 722 from an egocentric view. While video frame 706 and video frame 708 were flagged from an exocentric view but not corresponding video frame 716 and video frame 718, video frame 712 and video frame 722 can flag warning notification 732 for being an unsafe slide. In alternative embodiments of the present invention, an egocentric view can flag anomalous behavior without an exocentric view. Based on identifications, baseball coaching can be tailored more precisely to player needs and provide tools and feedback to execute the corrections efficiently and quickly.

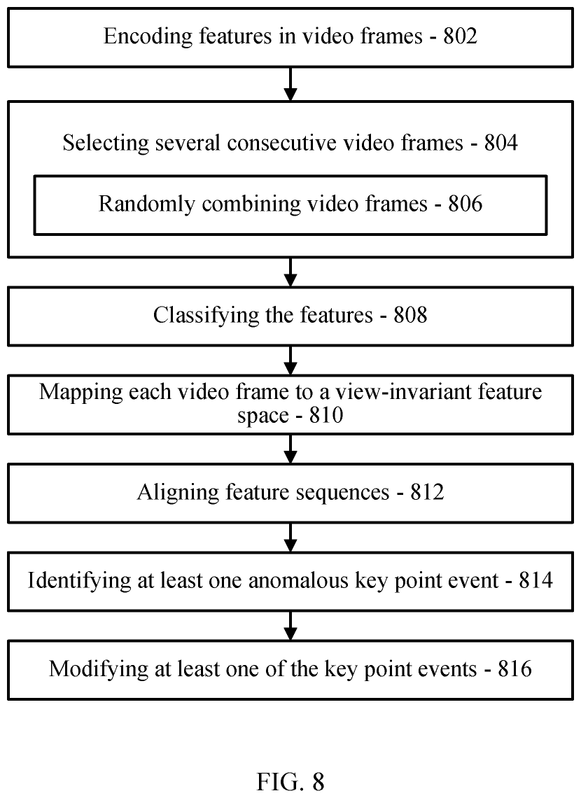

Referring to FIG. 8, a flow diagram illustrating a method of performing the framework is illustratively depicted. In block 802, features in video frames are encoded. The video frames can include key point events captured from different viewpoints at a same time, at least one viewpoint being an egocentric viewpoint and at least one viewpoint being an exocentric viewpoint. In block 804, several consecutive video frames are selected to form at least two temporally aligned sequences. In block 806, in an optional embodiment of the present invention, video frames can be randomly combined from the viewpoints to form the at least two temporally aligned sequences. In block 808, the features can be classified, including predicting a viewpoint from which a given feature originates. In block 810, in an optional embodiment of the present invention, each video frame can be mapped to a view-invariant feature space such that corresponding frames in the at least two temporally aligned sequences of the same time are mapped to same feature representations. In block 812, feature sequences can be aligned, wherein the aligning facilitates temporally logical embeddings across viewpoints. In block 814, anomalous key point events can be identified from the prediction. In block 816, an action is performed responsive to the at least one identified anomalous key point event. The action can be recommendations to improve the process in natural language, automatic process optimization such as, e.g., identifying, selecting and/or ordering tools to improve the process, documenting the inefficiency or inaccuracy, etc.

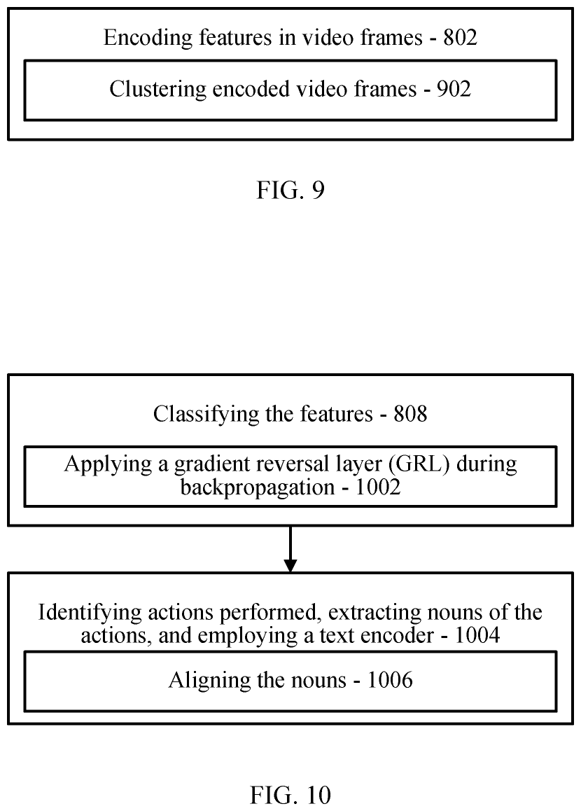

Referring to FIG. 9, additional details relating to block 802 are further included. In block 902, in an optional embodiment of the present invention, encoded video frames can be clustered by employing soft-k means for aligning the key points. Other clustering means are also contemplated. Additionally, alternatives to clustering are contemplated.

Referring to FIG. 10, additional details relating to block 808 are further included. In block 1002, in an optional embodiment of the present invention, a gradient reversal layer (GRL) can be applied during backpropagation to facilitate view-invariance. Facilitating can include, causing, encouraging, assisting, helping, enabling, etc. View-invariance can include ensuring the framework is affected by the features in the video frames such as object identity, etc., rather than the view, rotation, zoom, scale, lighting, etc. of the video frame. In block 1004, in an optional embodiment of the present invention, actions performed can be identified in the process from a description, nouns of the actions can be extracted, and/or a text encoder can be employed to form key point embeddings and key point noun embeddings. In block 1006, in an optional embodiment of the present invention, nouns can be aligned to objects encoded as features.

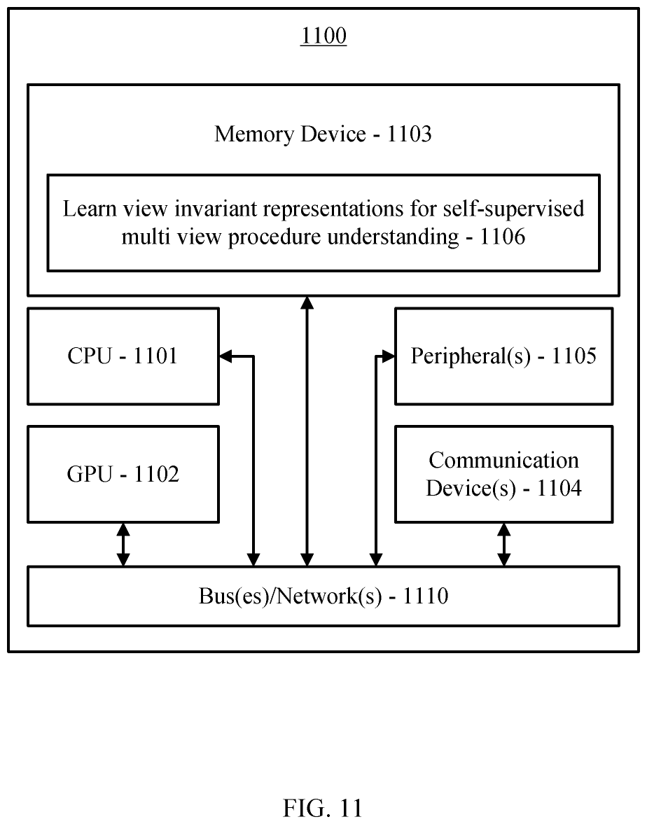

Referring to FIG. 11, a block diagram is shown for an exemplary processing system 1100, in accordance with an embodiment of the present invention. The processing system 1100 includes a set of processing units (e.g., CPUs) 1101, a set of GPUs 1102, a set of memory devices 1103, a set of communication devices 1104, and a set of peripherals 1105. The CPUs 1101 can be single or multi-core CPUs. The GPUs 1102 can be single or multi-core GPUs. The one or more memory devices 1103 can include caches, RAMs, ROMs, and other memories (flash, optical, magnetic, etc.). The communication devices 1104 can include wireless and/or wired communication devices (e.g., network (e.g., Wi-Fi®, etc.) adapters, etc.). The peripherals 1105 can include a display device, a user input device, a printer, an imaging device, and so forth. Elements of processing system 1100 are connected by one or more buses or networks (collectively denoted by the figure reference numeral 1110).

In an embodiment of the present invention, memory devices 1103 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 1103 store program code or software 1106 for a method to learn view-invariant representations for self-supervised multi-view procedure understanding. The software 1106 implements one or more functions of the systems and methods described herein for encoding features in video frames, the video frames including key point events captured from different viewpoints at a same time, at least one viewpoint being an egocentric viewpoint and at least one viewpoint being an exocentric viewpoint, selecting several consecutive video frames to form at least two temporally aligned sequences, and classifying the features including predicting a viewpoint from which a given feature originates. Software 1106 also includes aligning feature sequences to facilitate temporally logical embeddings across viewpoints, identifying at least one anomalous key point event from the prediction, and performing an action responsive to the at least one identified anomalous key point event.

Of course, the processing system 1100 may also include other elements (not shown), as readily contemplated by one of skill in the art, as well as omitting certain elements. For example, various other input devices and/or output devices can be included in processing system 1100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 1100 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 1100.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method comprising:
encoding features in video frames, the video frames including key point events captured from different viewpoints at a same time, at least one viewpoint being an egocentric viewpoint and at least one viewpoint being an exocentric viewpoint;
selecting several consecutive video frames to form at least two temporally aligned sequences;
classifying the features including predicting a viewpoint from which a given feature originates;
aligning feature sequences to facilitate temporally logical embeddings across viewpoints;
identifying at least one anomalous key point event from the prediction; and
performing an action responsive to the at least one identified anomalous key point event.

2. The method of claim 1, the classifying further comprising:
applying a gradient reversal layer (GRL) during backpropagation to facilitate view-invariance.

3. The method of claim 1, the classifying further comprising:
identifying actions performed in the video frames from a description;
extracting nouns of the actions; and
employing a text encoder to form key point embeddings and key point noun embeddings.

4. The method of claim 3, further comprising:
aligning the nouns to objects encoded as features.

5. The method of claim 1, the encoding further comprising:
clustering encoded video frames by employing soft-k means for aligning the key points events.

6. The method of claim 1, further comprising:
mapping each video frame to a view-invariant feature space such that corresponding frames in the at least two temporally aligned sequences of the same time are mapped to same feature representations.

7. The method of claim 1, the selecting further comprising:
randomly combining video frames from the viewpoints to form the at least two temporally aligned sequences.

8. A system comprising:
a processor; and
a memory storing computer-readable instructions that, when executed by the processor, cause the processor to:
encode features in video frames, the video frames including key point events captured from different viewpoints at a same time, at least one viewpoint being an egocentric viewpoint and at least one viewpoint being an exocentric viewpoint;
select several consecutive video frames to form at least two temporally aligned sequences;
classify the features including predicting a viewpoint from which a given feature originates;
align feature sequences to facilitate temporally logical embeddings across viewpoints;
identify at least one anomalous key point event from the prediction; and
perform an action responsive to the at least one identified anomalous key point event.

9. The system of claim 8, wherein the memory further causes the processor to:
apply a gradient reversal layer (GRL) during backpropagation to facilitate view-invariance.

10. The system of claim 8, wherein the memory further causes the processor to:
identify actions performed in the video frames from a description;
extract nouns of the actions; and
employ a text encoder to form key point embeddings and key point noun embeddings.

11. The system of claim 10, wherein the memory further causes the processor to:
align the nouns to objects encoded as features.

12. The system of claim 8, wherein the memory further causes the processor to:
cluster encoded video frames by employing soft-k means for aligning the key points events.

13. The system of claim 8, wherein the memory further causes the processor to:
map each video frame to a view-invariant feature space such that corresponding frames in the at least two temporally aligned sequences of the same time are mapped to same feature representations.

14. The system of claim 8, the selecting further comprising:
randomly combine video frames from the viewpoints to form the at least two temporally aligned sequences.

15. A computer program product comprising a non-transitory computer-readable storage medium containing computer program code, the computer program code when executed by one or more processors causes the one or more processors to perform operations, the computer program code comprising instructions to:
encode features in video frames, the video frames including key point events captured from different viewpoints at a same time, at least one viewpoint being an egocentric viewpoint and at least one viewpoint being an exocentric viewpoint;
select several consecutive video frames to form at least two temporally aligned sequences;
classify the features including predicting a viewpoint from which a given feature originates;
align feature sequences to facilitate temporally logical embeddings across viewpoints;
identify at least one anomalous key point event from the prediction; and
perform an action responsive to the at least one identified anomalous key point event.

16. The computer program product of claim 15, wherein the computer program code further includes instructions to:
apply a gradient reversal layer (GRL) during backpropagation to facilitate view-invariance.

17. The computer program product of claim 15, wherein the computer program code further includes instructions to:
identify actions performed in the video frames from a description;
extract nouns of the actions; and
employ a text encoder to form key point embeddings and key point noun embeddings.

18. The computer program product of claim 17, wherein the computer program code further includes instructions to:
align the nouns to objects encoded as features.

19. The computer program product of claim 15, wherein the computer program code further includes instructions to:
cluster encoded video frames by employing soft-k means for aligning the key points events.

20. The computer program product of claim 15, wherein the computer program code further includes instructions to:
map each video frame to a view-invariant feature space such that corresponding frames in the at least two temporally aligned sequences of the same time are mapped to same feature representations.
